(19) United States
(12) Patent Application Publication
(10) Pub. No.: US 2025/0311655 A1
(43) Pub. Date: Oct. 9, 2025

(54) COMPACT PULL-TYPE FLOATING ROW CLEANER

(71) Applicant: COPPERHEAD AGRICULTURAL PRODUCTS, LLC., Humboldt, SD (US)

(72) Inventor: Marlin Wayne UNRUH, Madrid, NE (US)

(21) Appl. No.: 19/014,645

(22) Filed: Jan. 9, 2025

Related U.S. Application Data
(60) Provisional application No. 63/573,681, filed on Apr. 3, 2024.

(51) Int. Cl. A01B 61/04; A01B 43/00

(52) U.S. Cl. CPC A01B 61/046; A01B 43/00

(57) ABSTRACT

A row cleaner is provided for use in agricultural tillage and includes an upper bracket mount having at least one upper pivot point for connecting a first end of at least one upper parallel linkage arm, and at least one lower pivot point for connecting a first end of at least one lower parallel linkage arm, a lower disk mount bracket mount having at least one disk mount upper pivot point for connecting a second end of each upper parallel linkage arm, and at least one disk mount lower pivot point for connecting a second end of each lower parallel linkage arm, the upper and lower pivot points on the upper bracket, and the disk mount upper and lower pivot points, each being non-vertically aligned with each other.

### RELATED APPLICATION

This application is a Non-Provisional of, and claims 35 U.S.C. 119 priority from, U.S. Provisional Application Ser. No. 63/573,681, filed Apr. 3, 2024, the entire contents of which are incorporated by reference herein.

### BACKGROUND

The present disclosure generally relates to agricultural tillage tools, and more particularly relates to an agricultural row crop debris clearing apparatus, also referred to as a row cleaner.

In the present application, the term “row cleaner” refers to an apparatus featuring a disk or a pair of disks fixed at the front, with various structures such as tines, employed for removing previous crop residue. The primary purpose of the row cleaner is to eliminate debris ahead of the row crop planter, ensuring an unobstructed path for the seed bed. Such preparation enhances seed germination by exposing the ground to sunlight and mitigating the potential allelopathic effects associated with decaying plant material.

Allelopathy, the interaction between plants, can hinder seed germination and adversely affect seedling roots when seeds are in proximity to decaying plant material.

The desire to avoid allelopathy in row crops has generated a need for an apparatus that can be attached to existing farm equipment, such as a planter, for clearing debris, such as mulch, plant stalks, and the like, from the ground, particularly during planting of a row crop, such as corn. It is well known that the optimum emergence of corn plants is a function of the precision with which the corn seeds are planted. It is important for desired emergence that the seed be planted at a precise depth and spacing during the planting operation. Since the depth of planting of the seed is controlled by rubber wheels of a planter, the presence of corn stalks, other mulch or debris in the row line during the planting operation can change the elevation of the wheels and therefore the planter itself. As a result, the proper seed planting and/or placement depth is impaired, which usually results in poor emergence of the crop.

It is also important that the debris be cleared from the row line if herbicides are to be applied to the field during planting. It is well known that the herbicide will be less effective if it merely contacts the debris rather than the soil itself. For these reasons, there has been considerable activity in the development of debris clearing apparatus that can be attached to the planter or other related equipment, which moves the mulch and debris out of the path of the planter so that accurate planting can be carried out and effective use of herbicides is achieved. Suitable examples of such debris clearing apparatus are disclosed in U.S. Pat. No. 6,279,666, U.S. Pub. No. 2012/0261149 and US Pub. No. 2016/0150714, all which are incorporated by reference.

Since the development of the invention of the '666 patent, the industry has developed tillage units with spring biased, vertically movable workheads that compensate for undulations in uneven ground. While these units have reduced many of the instances of debris clearing units losing contact with the seedbed, problems still remain. For example, in some cases, vertically movable workhead units still cause gouging of the seedbed due to a mechanical under reaction or over reaction to surface undulations.

Further, the orientation of conventional row cleaners to a tool bar or planter unit causes the row cleaners to sink into the seedbed. Some units have added gauging devices to prevent this unwanted sinking action. In one example, a generally planar, toothed row clearing wheel is attached to a fluted gauging device. In operation, such devices tend to hold, collect, and accumulate field crop debris instead of moving unwanted material away from the row cleaner, and also cause the row cleaner to ride over minor undulations in the field.

Another design consideration for such crop tillage devices is that the row cleaners are sufficiently retracted after use to avoid damage during transportation from field to field, often on irregular terrain. Conventional units employ parallel linkage systems to allow the row cleaner tillage wheels to accommodate operation on uneven ground. However, conventional units in the retracted position have been subject to impact damage during such transportation from field to field.

Still another design consideration is providing a row cleaner that is mountable to a variety of currently available planters and tillage tool bars. The presently available systems have proven unsatisfactory. Thus, there is a need for crop debris clearing units which address the above-listed design considerations.

### SUMMARY

The above-listed need is met or exceeded by the present compact pull-type floating row cleaner which is configured for clearing plant residue and debris, preventing blockage of planter components, and placing the seed beneath the ground surface in a desired manner. The present design achieves the above-identified objectives while providing versatility in mounting options and reducing the risk of damage to components during inter-use transportation.

One feature of the present row cleaner is an improved parallel linkage which provides a very compact profile of the unit in a retracted, travel position. This feature is achieved by configuring upper and lower linkage brackets with offset or non-vertically aligned pivot points so that the retracted linkage arms are disposed in a compact, closely-spaced, parallel orientation. The retracted row cleaner is sufficiently compact so that the respective pivot points are closer to being horizontally arranged rather than vertically arranged, and teeth of the retracted tillage wheel or disk are adjacent pivot points of an upper linkage bracket. In other words, the pivot points on each bracket are laterally displaced from each other, compared to conventional units where the pivot points are vertically arranged. In still other words, upper edges of the respective linkage arms are generally horizontally aligned with corresponding edges of the mounting brackets.

Another feature of the present row cleaner is an adjustable stop mechanism that controls the amount of extension of the row cleaner linkage in the operational or tillage position. The present adjustable stop mechanism is adjustable by the user without the use of tools. A biased lever has a toothed edge that engages a complementary toothed edge on a slidable stop element to hold it in position. A ratchet relationship is achieved. The stop element has an engagement surface that contacts a lobe on an upper linkage member. The stop mechanism cooperates with a fluid power, preferably pneumatic cylinder that lowers the row cleaner tillage wheels to the operational position.

A further feature of the present row cleaner is an upper linkage bracket that is configured for accommodating a variety of adapter brackets for facilitating mounting to several types of conventional tillage equipment, including row planters and vehicle tool bars.

More specifically, a row cleaner is provided for use in agricultural tillage and includes an upper bracket mount having at least one upper pivot point for connecting a first end of at least one upper parallel linkage arm, and at least one lower pivot point for connecting a first end of at least one lower parallel linkage arm, a lower disk mount bracket mount having at least one disk mount upper pivot point for connecting a second end of each upper parallel linkage arm, and at least one disk mount lower pivot point for connecting a second end of each lower parallel linkage arm, the upper and lower pivot points on the upper bracket, and the disk mount upper and lower pivot points, each being non-vertically aligned with each other.

In a preferred embodiment, a tillage disk is mounted to the disk mount bracket, and the row cleaner is configured for operating between a retracted position, with the upper and lower parallel linkage arms in a spaced, parallel orientation, and an operational position, with the upper and lower parallel linkage arms in an extended position, in the retracted position, teeth of the tillage disk are adjacent the lower pivot point of said upper bracket mount. In the present application, “adjacent” means in close proximity to, next to and/or overlapping when viewed from a side.

In an embodiment, the present row cleaner includes a pair of the at least one upper parallel linkage arms, each connected to the upper bracket mount and also to the disk mount, and being held is spaced relationship by an upper cylinder mount. In a preferred embodiment, the present row cleaner includes a pair of the at least one lower parallel linkage arms, each connected to the upper bracket mount and the disk mount, and defining a cylinder space for accommodating a fluid power cylinder mounted at a first cylinder end to the upper cylinder mount, and mounted at a second cylinder end to the disk mount. In an embodiment, upon operator control, the fluid power cylinder moves the row cleaner between a retracted position and an extended position.

In a preferred embodiment, the present row cleaner includes an adjustable stop mechanism associated with one of the upper bracket and the lower disk mount, and is configured for adjusting an operational position of the at least one upper parallel linkage arm and the at least one lower parallel linkage arm in an extended position. A feature of the present row cleaner is that such adjustment is achieved without the use of tools.

In an embodiment, the adjustable stop mechanism includes a stop lever pivotably mounted to one of the upper bracket and the lower disk mount, the stop lever has a toothed edge. A slidable stop member is slidably associated with one of the upper bracket and the lower disk mount, and having a complementary toothed edge configured for engaging the stop lever toothed edge. The slidable stop member has a stop end for engaging a complementary lobe on an associated one of the at least one upper and lower parallel linkage arms.

In a preferred embodiment, the stop lever is biased into engagement with the slidable stop member. Also, in an embodiment a grip is provided on the slidable stop member for operator engagement. It is preferred that the slidable stop member is configured for linear sliding action relative to the one of the upper bracket and the lower disk mount.

In a preferred embodiment, the upper bracket mount includes at least one vertical mounting surface and at least one horizontal mounting surface, both mounting surfaces having mounting apertures for accommodating adapters for securing the present row cleaner to conventional agricultural tillage equipment. Such tillage equipment includes planter units and conventional tillage tool bars.

In another embodiment, a row cleaner is provided for use in agricultural tillage and includes an upper bracket mount having a pair of upper pivot points for connecting a first end of a pair of upper parallel linkage arms, and a pair of lower pivot points for connecting a first end of a pair of lower parallel linkage arms, a lower disk mount bracket mount having a pair of disk mount upper pivot points for connecting a second end of each upper parallel linkage arm, and at least one disk mount lower pivot point for connecting a second end of each lower parallel linkage arm. The parallel linkage arms define a cylinder space for accommodating a fluid power cylinder mounted at a first cylinder end to an upper cylinder mount associated with the upper parallel linkage arms, and mounted at a second cylinder end to the disk mount. The fluid power cylinder moves the row cleaner between a retracted position and an extended position. Preferably included on the row cleaner is at least one tillage disk mounted to the lower disk mount and configured so that in the retracted position, teeth of the disk are adjacent at least one of the lower pivot points.

In yet another embodiment, a row cleaner is provided for use in agricultural tillage and includes an upper bracket mount having at least one upper pivot point for connecting a first end of at least one upper parallel linkage arm, and at least one lower pivot point for connecting a first end of at least one lower parallel linkage arm, a lower disk mount bracket mount having at least one disk mount upper pivot point for connecting a second end of each at least one upper parallel linkage arm, and at least one disk mount lower pivot point for connecting a second end of each at least one lower parallel linkage arm; and an adjustable stop mechanism associated with one of the upper bracket and the lower disk mount, and configured for adjusting an operational position of the at least one upper parallel linkage arm and the at least one lower parallel linkage arm in an extended position, such adjustment being achieved without the use of tools.

### BRIEF DESCRIPTION OF THE DRAWINGS

FIG. 1 is a side elevation of the present row cleaner in an extended position;

FIG. 2 is a front elevation of the row cleaner of FIG. 1;

FIG. 3 is a rear elevation of the row cleaner of FIG. 1;

FIG. 4 is a fragmentary top perspective view of the present row cleaner;

FIG. 5 is a reverse side fragmentary top perspective of the row cleaner of FIG. 5;

FIG. 6 is a side elevation of the row cleaner of FIG. 1 in a retracted position;

FIG. 7 is a fragmentary top perspective view of the row cleaner of FIG. 6;

FIG. 8 is a fragmentary side elevation of the present row cleaner;

FIG. 8A is a partial enlargement of the row cleaner of FIG. 8;

FIG. 9 is a top perspective view of an alternate embodiment of the present row cleaner;

FIG. 9A is a top perspective view of an adapter configured for use with the embodiment in FIG. 9A; and

FIG. 10 is a top perspective view of another alternate embodiment of the present row cleaner.

### DETAILED DESCRIPTION

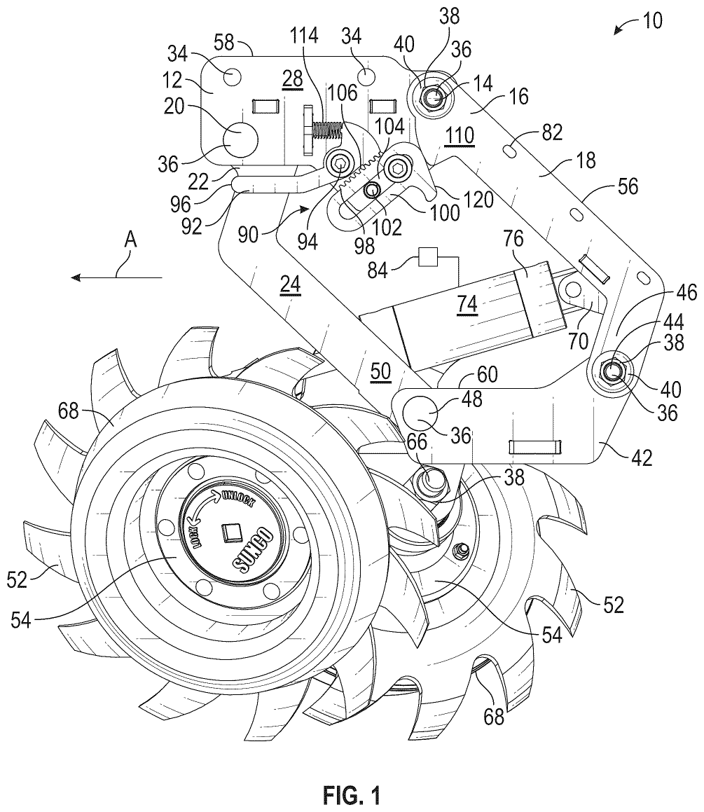

Referring now to FIGS. 1-5, the present row cleaner is generally designated 10 and is of the type used in agricultural tillage as described above for clearing the soil of debris prior to planting seeds. As such, the row cleaner 10 is mountable on a conventional row planter or on the toolbar of another tillage machine (both not shown) as are well known in the art. As seen in FIG. 1, the present row cleaner is configured for operation in the field in the direction of the arrow “A”.

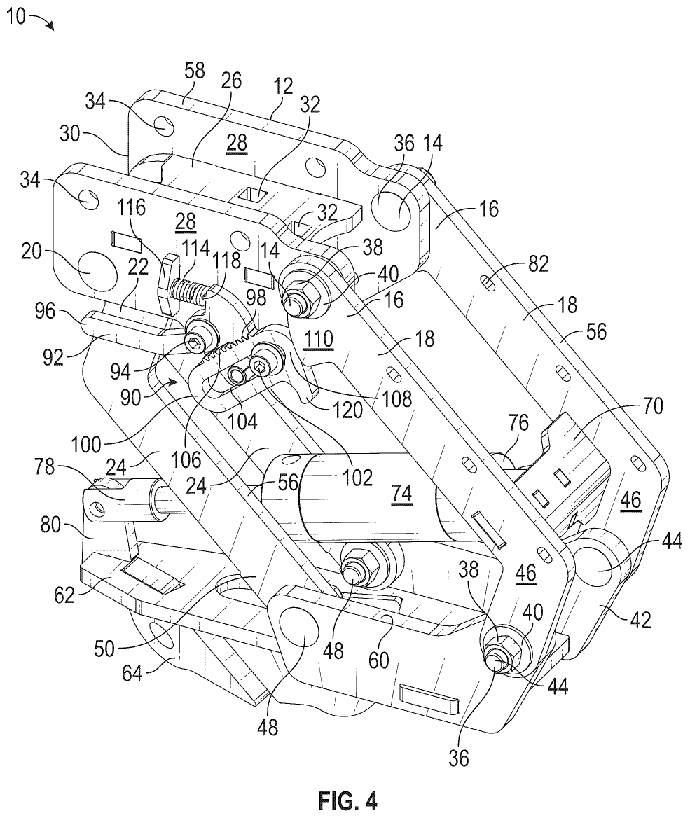

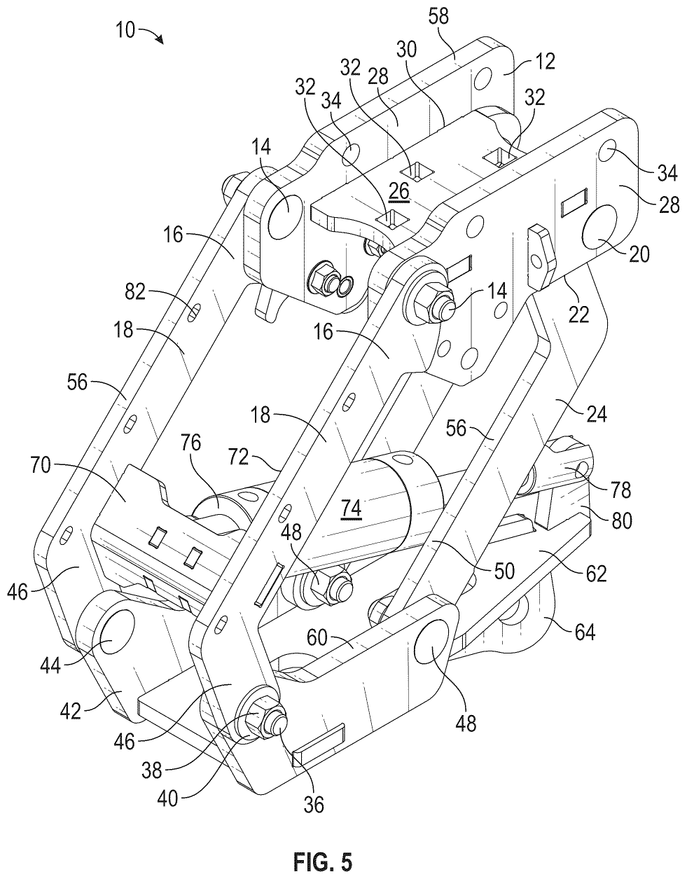

Included on the row cleaner 10 is an upper bracket mount 12 having at least one upper pivot point 14 for connecting a first end 16 of at least one upper parallel linkage arm 18, and at least one lower pivot point 20 for connecting a first end 22 of at least one lower parallel linkage arm 24. As best seen in FIGS. 4 and 5, the upper bracket mount 12 is generally “U”-shaped when viewed from the front and rear, having a horizontal base 26 sandwiched between two, spaced parallel vertical walls 28. The upper bracket mount 12 defines an adapter mounting space 30. The base 26 and the walls 28 are each provided with a plurality of mounting apertures, respectively designated 32 and 34 for accommodating adapters for enhancing connection to farm implements as will be described below.

Also, it is preferred that there is a pair of upper parallel linkage arms 18, each of which is connected to a corresponding one of the vertical walls 28 at the corresponding pivot point 14. Preferably there is also a pair of lower parallel linkage arms 24 connected to the upper bracket mount 12 at the lower pivot points 20. As is known in the art, the linkage arms 18 and 24 are connected at the pivot points 14 and 20 by bolts 36, nuts 38 and washers 40 for easy disassembly. However other fasteners are contemplated as are known in the art.

Referring now to FIGS. 1, 4, 5, 6 and 7, opposite the upper bracket mount 14 is a lower disk mount 42 having at least one disk mount upper pivot point 44 constructed and arranged for connecting a second end 46 of each upper parallel linkage arm 18, and at least one disk mount lower pivot point 48 for connecting a second end 50 of each lower parallel linkage arm 24. As is the case with the upper bracket mount 12, the lower disk mount 42 provides a laterally spaced pair of pivot points 44, 48 configured for accommodating the upper and lower parallel linkage arms 18, 24.

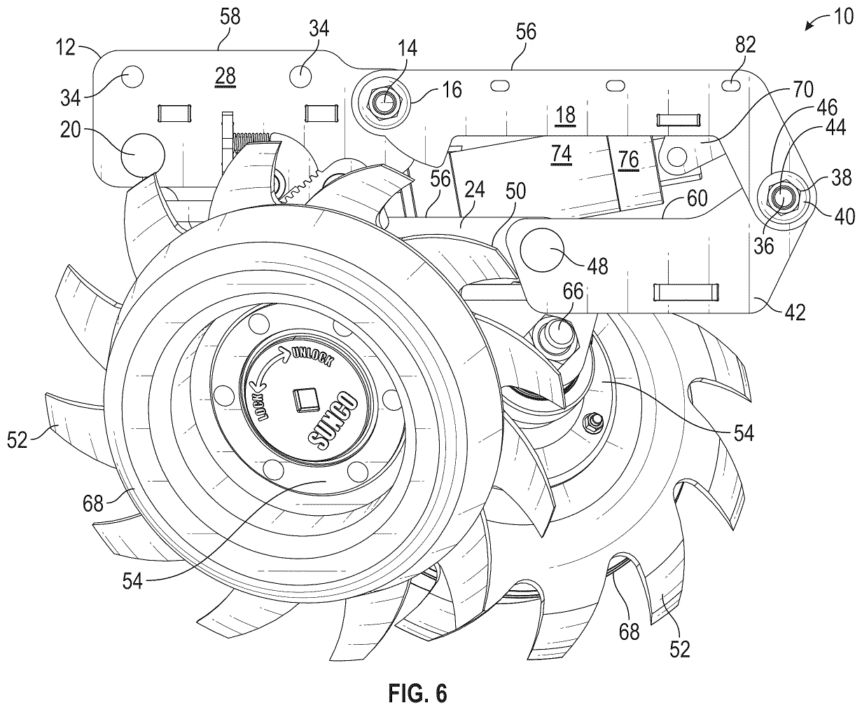

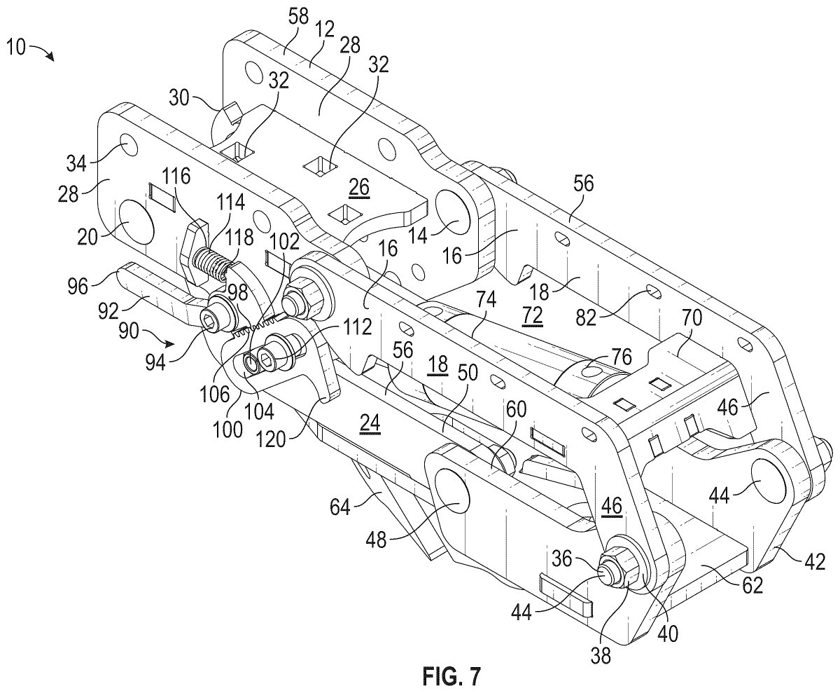

A feature of the present row cleaner 10 is that the upper and lower pivot points 14, 20 on the upper bracket mount 12, and the disk mount upper and lower pivot points 44, 48 each are non-vertically aligned with each other. It has been found that by laterally displacing the respective pivot points 14, 20 and 44, 48, the parallel linkage arms 18, 24 are able to achieve a more compact retracted position (FIGS. 6 and 7) than that which is achieved by conventional, parallel linkage row cleaners.

As such, in the retracted position, the linkage arms 18, 24 are closely spaced in parallel, horizontally arranged positions. The retracted row cleaner 10 is sufficiently compact so that the respective pivot points 14, 20 and 44, 48 are closer to being horizontally arranged rather than vertically arranged, and teeth 52 of a retracted tillage wheel or disk 54 are adjacent pivot points 14, 20 of the upper linkage bracket mount 12. Also, the pivot points 14, 20 and 44, 48 on each bracket mount 12, 42 are laterally displaced from each other, compared to conventional units where the pivot points are vertically arranged. Furthermore, upper edges 56 of the respective linkage arms 18, 24 are generally horizontally aligned with corresponding edges 58, 60 of the bracket mounts 12, 42. Accordingly, upon achieving the present retracted position, the present row cleaner 10 is less susceptible to impact damage as the unit is moved from field to field, or into or out of storage locations.

Also, the present row cleaner 10 is considered to be a “pull-type” cleaner, in that pivot points 44, 48 on the lower disk mount bracket 42 are behind the upper bracket mount pivot points 14, 20. In contrast, in a “push-type” style, the lower pivot points 44, 48 are ahead of the upper pivot points 14, 20 in the direction of travel. In the present row cleaner 10, the disks 54 are positioned unusually forward on the disk mount bracket 42. Despite their forward position, the disks 54 are still being pulled. This arrangement has been found to enhance performance and reduce the disks 54 being bogged down in loose soil.

In operation, the parallel linkage arms 18, 24 flex or pivot to allow the disk 54 to follow uneven ground and maintain contact so that plant debris can still be removed from the planting site regardless of the terrain.

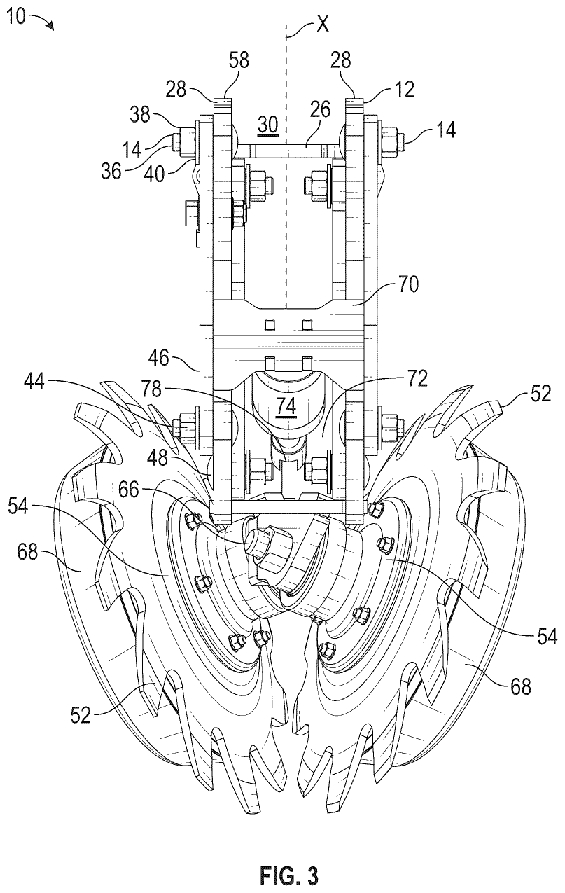

Referring now to FIGS. 1, 4 and 6, details of the mounting of the tillage disk 54 are shown in greater detail. Depending from a floor 62 of the disk mount 42 is a pair of ears or flanges 64 each configured for receiving a threaded stem 66 of one of a pair of the tillage disks 54. As known in the art, the flanges 64 are angled relative to the floor 62 to orient the disks 54 one in front of the other and also at an oblique angle relative to a vertical axis “X” (FIG. 3) passing through the floor. Also as is known, the disks 54 include internal bearings to facilitate rotation relative to the disk mount 42. While shown in a “saw-tooth” pattern, it is contemplated that the number and configuration of the teeth 52 on the disk 54 may vary to suit the application and type of plant or crop residue being cleared. Preferably, each disk 54 is provided with a rubber-like tire 68 that engages the ground surface once the row cleaner 10 is in the extended or operational position depicted in FIG. 1.

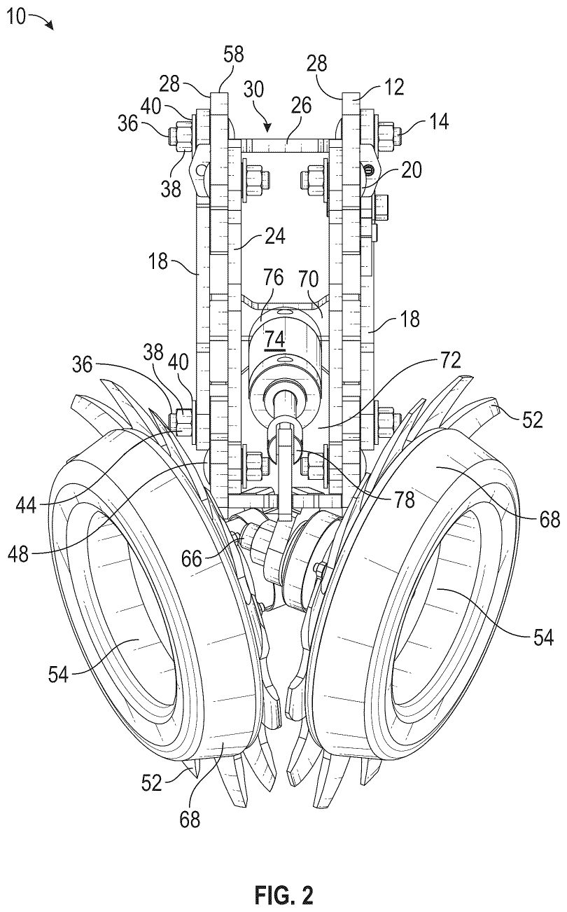

Referring now to FIGS. 1-5, besides their connection to the upper bracket mount 12 and the disk mount 42, the upper parallel linkage arms 18 are held or supported in spaced relationship by an upper cylinder mount 70. Also, a space between the linkage arms 18 and 24 is defined as a cylinder space 72 (FIGS. 2 and 3) configured for accommodating a fluid power cylinder 74 mounted at a first cylinder end 76 to the upper cylinder mount 70, and mounted at a second cylinder end 78 to an ear 80 projecting vertically from the floor 62 of the disk mount 42. While in the preferred embodiment, the fluid power cylinder 74 is pneumatic, hydraulic cylinders are also contemplated depending on the application. Also, it is contemplated that the fluid power cylinder 74 is mounted so that the first end 76 is either the rod end or the blind end, as is known in the art. Optionally, the arms 18 and/or 24 are provided with zip tie mounting slots 82 for securing appropriate fluid power lines (not shown).

An operator controls the pressurization of the fluid power cylinder 74 using a control unit 82 (FIG. 1) located in a tractor cab (not shown). Since it is contemplated that a planter will have multiple row cleaners 10 corresponding to the number of crop rows to be planted, the control unit 84 is constructed and arranged so that all of the row cleaners move as one between the retracted position of FIG. 6 and the extended or operational position of FIG. 1.

Referring now to FIGS. 1, 4, 7, 8 and 8A, depending on the work environment, soil conditions, type of crop to be planted or other considerations, the operator often needs to adjust the working height of the tillage disks 54 in the extended, operational position shown in FIG. 1. As described above, it is contemplated that multiple row cleaners 10 will be employed on a planter corresponding to the number of crop rows planted at a time, so that multiple height adjustments will be needed. As such, the adjustment should be made quickly to improve overall efficiency of the planting operation.

In the present row cleaner 10, such adjustment is easily achieved without the use of tools using the present adjustable stop mechanism, generally designated 90. The adjustable stop mechanism 90 is associated with one of the upper bracket mount 12 and the lower disk mount 42, and is configured for easily adjusting an operational position of the linkage arms at least one upper parallel linkage arm and said at least one lower parallel linkage arm in an extended position, such adjustment being achieved without the use of tools.

It is preferred that the adjustable stop mechanism 90 is mounted to the upper bracket mount 12 to engage one of the upper parallel linkage arms 18, which will be described below, but it is also contemplated that the mechanism is optionally mounted on the lower disk mount 42 to engage one of the lower parallel linkage arms 24. Included on the adjustable stop mechanism 90 is a stop lever 92 pivotably mounted to the upper bracket mount 12 at a pivot point 94. The stop lever 92 has a handle 96 at one end, and a toothed edge 98 at an opposite end. A slidable stop member 100, also referred to as an oval gear rack is slidably associated with the upper bracket mount 12 upon pins 102 engaged in a slot 104 of the member 100. It is preferred that the pins 102 are linearly arranged to accommodate the slot 104 and permit linear sliding movement of the slidable stop member 100 relative to the toothed edge 98.

The slidable stop member 100 also has a complementary toothed edge 106 configured for engaging the stop lever toothed edge 98 in a ratchet relationship. Also, the slidable stop member 100 has a stop end 108 configured for engaging a complementary depending lobe 110 on the upper parallel linkage arm 18. Preferably, one of the pins 102 incorporates a retaining bolt and washer 112 for slidably securing the slidable stop member 100 to the upper bracket mount 12. The stop lever 92 is preferably biased into engagement with the slidable stop member 100. In an embodiment, the biasing force is provided by a spring 114 captured on a stem 116 secured to the upper bracket mount 12 and accommodating a lug 118 on the stop lever 92.

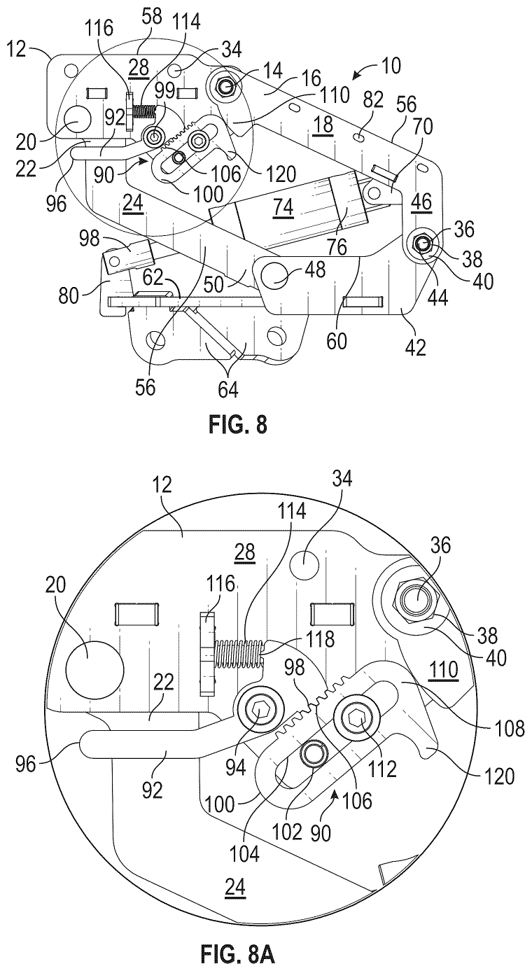

In the rest position shown in FIG. 8A, the teeth on the toothed edge 98 of the stop lever 92 tightly engage the corresponding teeth on the slidable stop member 100 and hold the member in position. When the operator needs to adjust the operational position of the disk 54, the handle 96 is pushed down, overcoming the force of the spring 114 and disengaging the toothed edges 98, 106. At this point, the operator can slide the slidable stop member 100 as desired by moving the stop end 108 relative to the lobe 110. In a preferred embodiment, movement of the slidable stop member 100 is facilitated by providing a grip 120 configured for operator engagement. As the stop lever 92 is depressed as described above, the operator can easily pull the slidable stop member 100 back and forth on the pins 102 by grasping the grip 120 until the desired operational position of the disk 54 is achieved.

Referring now to FIGS. 4, 5, 7, 9 and 10, another feature of the present row cleaner 10 is that it is readily adaptable for mounting to a variety of agricultural equipment, including but not limited to row planters and tool bars of tillage devices. More specifically, the upper bracket mount 12 includes the at least one vertical mounting surface formed by the walls 28 and at least one horizontal mounting surface formed by the horizontal base 26. These surfaces combine to define the adapter mounting space 30, configured for accommodating various adapters that are in turn constructed and arranged for easily mounting the row cleaner 10 to a desire piece of tillage equipment. As mentioned above, the mounting surfaces 26, 28 each have mounting apertures 32, 34 for securing various adapters.

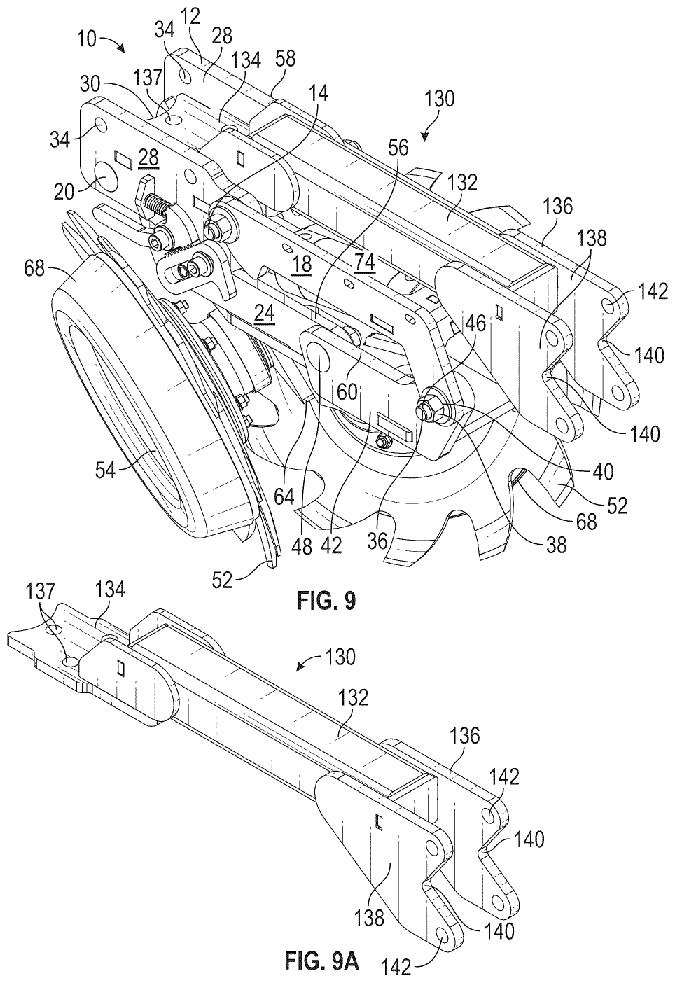

Referring now to FIGS. 9, and 9A an adapter for a row planter is generally designated 130. The adapter 130 is configured for connecting the present row cleaner 10 to a row planter. Included on the adapter 130 is an elongate main shaft 132 separating a row cleaner attachment 134 and a row planter attachment 136. As is seen in FIG. 9, the row cleaner attachment 134 is shaped to conform to the horizontal base 26, and to be secured thereto by fasteners such as bolts 36 and nuts 38 or the like passing through openings 137 and the mounting apertures 32.

Opposite the row cleaner attachment 134, the row planter attachment 136 includes a pair of spaced, parallel rearwardly extending tabs 138, each having a notch 140 and at least one planter mount aperture 142 configured for respectively accommodating mounting points on the planter and receiving suitable fasteners such as bolts 36 and nuts 38 for securing the adapter 130 in position.

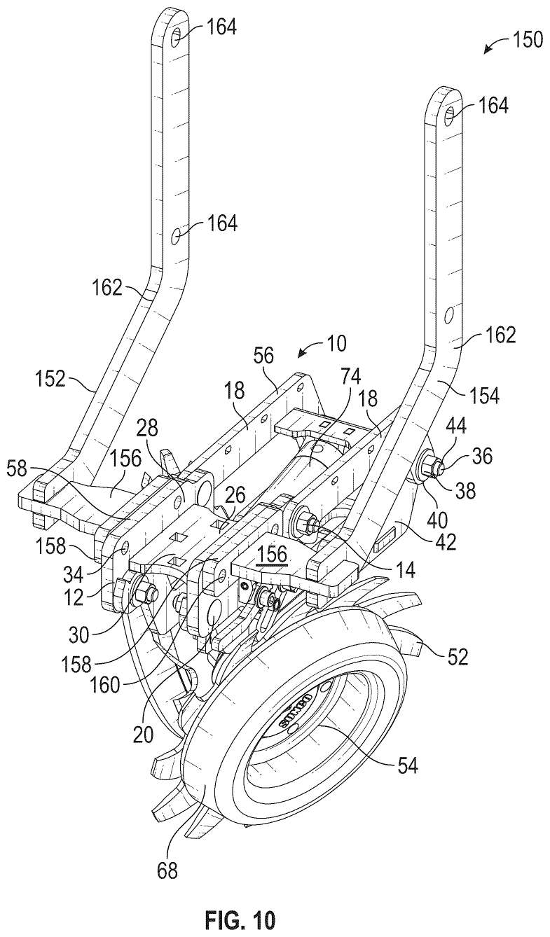

Referring now to FIG. 10, a tool bar adapter is generally designated 150. Included on the adapter 150 are left and right side brackets 152, 154 which are mirror images of each other. Each side bracket 152, 154 includes an attachment base 156 including a mount bar 158 with holes 160 in alignment with the mounting apertures 34 on the vertical walls 28. Suitable fasteners, such as bolts 36 and nuts 38 are used to secure the mount bar 158 to the row cleaner upper mount bracket 12. Attached to each attachment base 156 by welding, fasteners or the like, is an angled or dogleg toolbar elbow 162 constructed and arranged to be mountable to conventional tillage equipment toolbars. Suitable openings 164 are provided in each toolbar elbow 162 for attachment, using bolts 36 and nuts 38 or the like, as needed to corresponding toolbar fittings (not shown). It is contemplated that the precise configuration of the adapters 130, 150 may change as needed to suit the changing configurations of conventional tillage equipment.

While a particular embodiment of the present compact pull-type floating row cleaner has been described herein, it will be appreciated by those skilled in the art that changes and modifications may be made thereto without departing from the invention in its broader aspects and as set forth in the following claims.

1. A row cleaner for use in agricultural tillage, comprising:
an upper bracket mount having at least one upper pivot point for connecting a first end of at least one upper parallel linkage arm, and at least one lower pivot point for connecting a first end of at least one lower parallel linkage arm;
a lower disk mount bracket mount having at least one disk mount upper pivot point for connecting a second end of each said at least one upper parallel linkage arm, and at least one disk mount lower pivot point for connecting a second end of each said at least one lower parallel linkage arm;
said upper and lower pivot points on said upper bracket, and said disk mount upper and lower pivot points, each being non-vertically aligned with each other.

2. The row cleaner of claim 1, further including a tillage disk mounted to said disk mount bracket, and said row cleaner is configured for operating between a retracted position, with said upper and lower parallel linkage arms in a spaced, parallel orientation, and an operational position, with said upper and lower parallel linkage arms in an extended position, in said retracted position, teeth of said tillage disk being adjacent said lower pivot point of said upper bracket mount.

3. The row cleaner of claim 1, further including a pair of said at least one upper parallel linkage arms, each connected to said upper bracket mount and said disk mount, and being held is spaced relationship by an upper cylinder mount.

4. The row cleaner of claim 3, further including a pair of said at least one lower parallel linkage arms, each connected to said upper bracket mount and said disk mount, and defining a cylinder space for accommodating a fluid power cylinder mounted at a first cylinder end to said upper cylinder mount, and mounted at a second cylinder end to said disk mount.

5. The row cleaner of claim 4, wherein, upon operator control, said fluid power cylinder moves said row cleaner between a retracted position and an extended position.

6. The row cleaner of claim 1, further including an adjustable stop mechanism associated with one of said upper bracket and said lower disk mount, and configured for adjusting an operational position of said at least one upper parallel linkage arm and said at least one lower parallel linkage arm in an extended position, such adjustment being achieved without the use of tools.

7. The row cleaner of claim 6, wherein said adjustable stop mechanism includes a stop lever pivotably mounted to one of said upper bracket and said lower disk mount, said stop lever having a toothed edge, and a slidable stop member being slidably associated with one of said upper bracket and said lower disk mount, and having a complementary toothed edge configured for engaging said stop lever toothed edge, said slidable stop member having a stop end for engaging a complementary lobe on an associated one of said at least one upper and lower parallel linkage arms.

8. The row cleaner of claim 7, wherein said stop lever is biased into engagement with said slidable stop member.

9. The row cleaner of claim 7, further including a grip on said slidable stop member for operator engagement.

10. The row cleaner of claim 7, wherein said slidable stop member is configured for linear sliding action relative to said one of said upper bracket and said lower disk mount.

11. The row cleaner of claim 1, wherein said upper bracket mount includes at least one vertical mounting surface and at least one horizontal mounting surface, both said mounting surfaces having mounting apertures for accommodating adapters for securing said row cleaner to conventional agricultural tillage equipment.

12. A row cleaner for use in agricultural tillage, comprising:
an upper bracket mount having a pair of upper pivot points for connecting a first end of a pair of upper parallel linkage arms, and a pair of lower pivot points for connecting a first end of a pair of lower parallel linkage arms;
a lower disk mount bracket mount having a pair of disk mount upper pivot points for connecting a second end of each said upper parallel linkage arm, and at least one disk mount lower pivot point for connecting a second end of each said lower parallel linkage arm;
said parallel linkage arms defining a cylinder space for accommodating a fluid power cylinder mounted at a first cylinder end to an upper cylinder mount associated with said upper parallel linkage arms, and mounted at a second cylinder end to said disk mount; said fluid power cylinder moves said row cleaner between a retracted position and an extended position; and
at least one tillage disk mounted to said lower disk mount and configured so that in said retracted position, teeth of said disk are adjacent at least one of said lower pivot points.

13. The row cleaner of claim 12, further including an adjustable stop mechanism associated with one of said upper bracket and said lower disk mount, and configured for adjusting a location of said at least one upper parallel linkage arm and said at least one lower parallel linkage arm in an extended position, such adjustment being achieved without the use of tools.

14. The row cleaner of claim 13, wherein said adjustable stop mechanism includes a stop lever pivotably mounted to one of said upper bracket and said lower disk mount, said stop lever having a toothed edge, and a slidable stop member being slidably associated with one of said upper bracket and said lower disk mount, and having a complementary toothed edge configured for engaging said stop lever toothed edge, said slidable stop member having a stop end for engaging a complementary lobe on an associated one of said at least one upper and lower parallel linkage arms, said stop lever being biased against said slidable stop member.

15. The row cleaner of claim 12, wherein said upper bracket mount includes at least one vertical mounting surface and at least one horizontal mounting surface, both said mounting surfaces having mounting apertures for accommodating adapters for securing said row cleaner to conventional agricultural tillage equipment.

16. A row cleaner for use in agricultural tillage, comprising:
an upper bracket mount having at least one upper pivot point for connecting a first end of at least one upper parallel linkage arm, and at least one lower pivot point for connecting a first end of at least one lower parallel linkage arm;
a lower disk mount bracket mount having at least one disk mount upper pivot point for connecting a second end of each said at least one upper parallel linkage arm, and at least one disk mount lower pivot point for connecting a second end of each said at least one lower parallel linkage arm; and
an adjustable stop mechanism associated with one of said upper bracket and said lower disk mount, and configured for adjusting an operational position of said at least one upper parallel linkage arm and said at least one lower parallel linkage arm in an extended position, such adjustment being achieved without the use of tools.

17. The row cleaner of claim 16, wherein said adjustable stop mechanism includes a stop lever pivotably mounted to one of said upper bracket and said lower disk mount, said stop lever having a toothed edge, and a slidable stop member being slidably associated with one of said upper bracket and said lower disk mount, and having a complementary toothed edge configured for engaging said stop lever toothed edge, said slidable stop member having a stop end for engaging a complementary lobe on an associated one of said at least one upper and lower parallel linkage arms, said stop lever is biased into engagement with said slidable stop member.

18. The row cleaner of claim 16, wherein said upper bracket mount includes at least one vertical mounting surface and at least one horizontal mounting surface, both said mounting surfaces having mounting apertures for accommodating adapters for securing said row cleaner to conventional agricultural tillage equipment.

19. The row cleaner of claim 16, wherein said parallel linkage arms define a cylinder space for accommodating a fluid power cylinder mounted at a first cylinder end to an upper cylinder mount associated with said upper parallel linkage arms, and mounted at a second cylinder end to said disk mount;
said fluid power cylinder moves said row cleaner between a retracted position and an extended position; and
at least one tillage disk mounted to said lower disk mount and configured so that in said retracted position, teeth of said disk are adjacent at least one of said lower pivot points.
